(19) United States
(12) Patent Application Publication
(10) Pub. No.: US 2002/0130136 A1
(43) Pub. Date: Sep. 19, 2002

(54) System and method for monitoring usage and status of a beverage-dispensing machine

(76) Inventor: Noel B. Segal, Rockville, MD (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/805,972

(22) Filed: Mar. 15, 2001

(51) Int. Cl. B67D 5/56

(52) U.S. Cl. 222/40; 222/129.1

(57) ABSTRACT

The system and method for monitoring usage and status of a beverage-dispensing machine is provided. The system and method remotely monitors operating status and usage parameters of a beverage of a beverage-dispensing machine. The monitoring system includes an input port configured to be coupled to the beverage-dispensing machine, a monitoring unit connected to the input port, for receiving a monitor signal from the beverage-dispensing machine and generating an ingredient use and status signal, a memory device connected to the monitoring unit, for storing the ingredient use and status signal to generate ingredient use and status data, and a power source supplying power to the monitoring system. The method of monitoring usage of a beverage dispensed from a beverage-dispensing machine having a control unit is also provided. The method includes steps of coupling a monitoring unit the control unit, receiving a monitor signal from the control unit, generating an ingredient use and status signal, storing the ingredient use and status signal, and generating ingredient use and status data.

### BACKGROUND OF THE INVENTION

1. Field of the Invention

The present invention relates to a system and method for monitoring usage and status of a beverage-dispensing machine. In particular, the invention is directed to a system and method to remotely monitor operating status and usage parameters, such as a volume and a flow rate, of a beverage of a beverage-dispensing machine.

2. Description of the Related Art

Beverage-dispensing machines are commonly used in convenience stores, fast-food franchise stores, theaters, amusement parks, restaurants and other similar locations. Typically, a beverage-dispensing machine can serve multiple beverages, including carbonated drinks and non-carbonated drinks. Also, there are beverage-dispensing machines that have a refrigeration capability and dispense carbonated or non-carbonated frozen beverages, such as a “Slurpee®”, a smoothie, frozen cocktail or a milk shake. These machines quickly dispense a beverage into a container by actuating a switch, such as a lever located near a nozzle for the beverage.

Generally, the frozen carbonated beverage-dispensing machines have a water supply and containers for syrup and carbon dioxide (CO₂), and mix them at a desired ratio to fill a freezing cylinder used to produce a frozen carbonated beverage. Similarly, a non-carbonated beverage machine has a reservoir for holding mix or syrup that may or may not be mixed with water as an ingredient. The carbonated beverage machine may have a solenoid valve, a pump, or other device to control the flow of the syrup, water and CO₂ from the water supply and containers, while the non-carbonated machine may have a solenoid valve, a pump, or other device to control the flow of the mix or syrup, or may rely on gravity to fill a freezing cylinder.

Typically, a frozen beverage-dispensing machine has a freezing cylinder or “chamber” connected to a water supply and containers for syrup and CO₂ or any other ingredients supply. The ingredients are mixed and frozen in the chamber to a desired consistency for consumption. The supply of the water and ingredients is controlled by solenoid valves located between the water supply/ingredient container and the chamber. The machine also controls and monitors temperature and consistency of the frozen beverage in the chamber as well as pressure within the chamber. The ratio of the mixture of the syrup, CO₂ and water is carefully controlled. These machines generally utilize a pressure switch/transducer that senses low pressure in the mixing chamber and opens solenoid valves to supply the desired amount of water and ingredients to the chamber. The beverage-dispensing machine provides consumers with beverages in a short period of time.

In the industry involving such beverage-dispensing machines, a machine supplier often provides a beverage-dispensing machine to a client customer free of charge on the basis that the customer purchases the mix or syrup from the supplier. As described above, the ingredients, such as syrup, necessary to make beverages are typically supplied within a container. The ingredients in the container may be poured into and stored in the reservoir, or the container may be directly connected or attached to the beverage-dispensing machine to supply the ingredients. When the machine runs out of the syrup of mix, establishments where the machine is located need to refill or replace the empty ingredient container and must therefore have available stock of the containers. Ultimately, they may need to place orders for new mix or inform the syrup ingredient supplier and have a new container delivered and replaced it for the empty container. Where the product is not refilled, replaced or reordered on a timely basis, significant income can be lost.

Moreover, the ingredient suppliers do not always know exactly when to deliver new containers to the site of the beverage-dispensing machine. Because the machine supplies need to be always ready to deliver new containers, they often stock many containers of many different types of beverages and carry large inventories. However, if the suppliers knew how much ingredients were going through the machine at a particular site, the suppliers could forecast the ingredient need for the machine and better control the inventory. The suppliers may not need to carry a large inventory at all times, or they can eliminate the inventory altogether by measuring how mush mix or syrup is used and charging on that basis. As a result, the suppliers can, if they wish, charge the customer by use of the machine rather than the ingredients purchased, and the customers can purchase the ingredients from any supplier and at the best price they can negotiate.

For the reasons given, the machine suppliers are interested in knowing how much of the ingredients in the machine are consumed, and there is a need to monitor the consumption of beverages from beverage-dispensing machines.

### SUMMARY OF THE INVENTION

One object of the invention is, therefore, to provide a system and method for conveniently and efficiently monitoring usage of a beverage-dispensing machine. Another object of the invention is to provide a monitoring system and method that allows a person at a remote location to know how much ingredients in the machine are consumed. Another object of the invention is to remotely monitor the operating status of the machine.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

To achieve the objects and in accordance with the purpose of the invention, as embodied and broadly described herein, a monitoring system for monitoring usage of a beverage-dispensing machine, includes an input port configured to be coupled to the beverage-dispensing machine, a monitoring unit connected to the input port, for receiving a monitor signal from the beverage-dispensing machine and generating an ingredient use and status signal, a memory device connected to the monitoring unit, for storing the ingredient use and status signal to generate ingredient use and status data, and a power source supplying a power to the monitoring system. In one aspect of the invention, the monitoring system is provided with a communication device for sending the ingredient use and status data set via a communication link to a remote location.

According to another aspect of the invention, a beverage-dispensing device includes a beverage-dispensing nozzle, an ingredient supply connected to the nozzle, a valve disposed between the nozzle and the ingredient supply, a control unit, and a monitoring system. The monitoring system has an input port configured to be coupled to the sensor, a monitoring unit connected to the input port, for receiving a monitor signal from the control unit and generating an ingredient use and status signal, a memory device connected to the monitoring unit, for storing the ingredient use and status signal to generate ingredient use and status data, and a power source supplying a power to the monitoring system.

In yet another aspect of the invention, a method of monitoring usage and status of beverage dispensed from a beverage-dispensing machine having a control unit is provided. The method includes the steps of coupling a monitoring unit to the control unit, receiving a monitor signal from the control unit, generating an ingredient use and status signal from the monitor signal, storing the ingredient use and status signal, and generating ingredient use and status data from the ingredient use and status signal. In one aspect, the method further includes a step of sending the ingredient use and status data via a communication link to a remote location.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings,

FIG. 1 is a schematic diagram of a beverage-dispensing machine having a monitoring system according to one embodiment of the present invention;

FIG. 2 is a partial diagram of a beverage-dispensing machine having a monitoring system shown in FIG. 1;

FIG. 3 is a top expanded view of one preferred embodiment of the monitoring system with a communication device according to the invention;

FIG. 4 is a top view of the monitoring system assembled with the communication device shown in FIG. 3;

FIG. 5 is a partial circuit diagram of a monitoring system according to one embodiment of the invention;

FIG. 6 is a circuit diagram of a communication device according to the present invention; and

FIG. 7 is a partial circuit diagram of the monitoring system according to one embodiment of the present invention.

### DESCRIPTION OF THE PREFERRED EMBODIMENT

Reference will now be made in detail to the present preferred embodiments of the invention, examples of which are illustrated in the accompanying drawings. Wherever possible, the same reference numbers will be used throughout the drawings to refer to the same or like parts.

In accordance with the invention, a monitoring system for monitoring usage and status of a beverage-dispensing machine is provided. Preferably, the monitoring system includes an input port configured to be coupled to the beverage-dispensing machine, a monitoring unit connected to the input port, for receiving a monitor signal from the beverage dispensing machine and generating an ingredient use and status signal, a memory device connected to the monitoring unit, for storing the ingredient use and status signal to generate an ingredient use and status data, and a power source supplying power to the monitoring system.

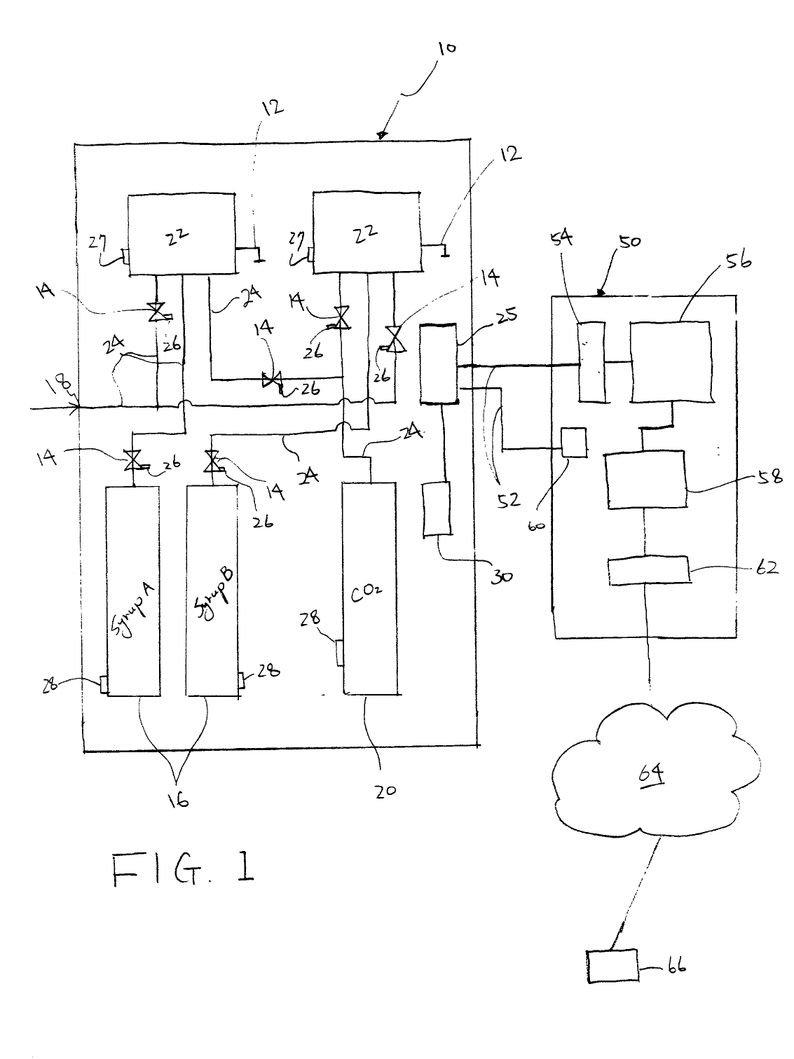

FIG. 1 illustrates one exemplary embodiment of a beverage-dispensing machine having a monitoring system according to the present invention. In FIG. 1, a beverage-dispensing machine is shown generally by reference numeral 10, and it can produce a carbonated or non-carbonated frozen beverage, such as a “Slurpee®”, a smoothie, a frozen cocktail or a milk shake. The application of the invention, however, is not limited to these beverages. The dispensing machine can also be for a carbonated or non-carbonated non-frozen beverage, such as a soda and juice.

Beverage-dispensing machine 10 preferably includes a beverage-dispensing nozzle 12, an ingredient supply connected to nozzle 12, and a valve 14 disposed between nozzle 12 and the ingredient supply. As a part of the ingredient supply, beverage-dispensing machine 10 contains a set of syrup supply tanks, bags, boxes, or any other container (used interchangeably throughout the specification) 16, a water supply 18, and a CO₂ tank or bulk storage device 20. Each of syrup tanks 16 contains syrup (Syrup A, Syrup B) used to make a frozen beverage. This beverage-dispensing machine is quipped with two separate syrup tanks and can produce beverages with two different flavors. However, the machine may contain more syrup tanks to produce beverages with many different flavors. Water may be externally provided by connecting water supply 18 to a water supply hose. Alternatively, beverage-dispensing machine 10 may be equipped with a water tank. Some machines may not have a water connection at all. Moreover, beverage-dispensing machine 10 has a set of mixing tanks 22 connected to the ingredient supply by conduits 24. The ingredients (syrup, water and CO₂) for each of the beverages may travel from the ingredient supply to a corresponding mixing tank 22 through conduits 24. In mixing tank 24, the ingredients are mixed then enter the freezing cylinder to be frozen for consumption. Once the mixture of the ingredient reaches a desired temperature and consistency, a user may dispense a beverage into a container through nozzle 12 by manipulating an actuator, such as a lever or sensor.

As shown in FIG. 1, beverage-dispensing machine 10 includes the valve 14 located at conduit 24 between each of the ingredient supply and mixing tanks 22. Valve 14 controls the flow of each of the ingredients supplied into mixing chambers 22 so that the desired flavor and consistency of the beverage will be produced from the beverage-dispensing machine. Preferably, valve 14 is a solenoid valve that opens and closes to control the flow rate of the ingredient traveling through it.

Beverage-dispensing machine 10, furthermore, may include a control unit or a universal board 25. Control unit 25 is electrically connected to each of valves 14 (the connections are not shown in the drawings) and controls the opening and closing operation of valve 14 for each of the ingredients by sending a signal. In one embodiment, a measurement sensor 26 is provided with valve 14 and the actuation of each of valves 14 can be monitored with measurement sensor 26. Measurement sensor 26 may sense the open and close operation of valve 14 as well as duration of opening of valve 26, and send an ingredient volume, actuation, or duration signal to control unit 25. By measurement of the flow rate or the duration of opening of valve 14, the volume or weight passing through valve can be accurately sensed by sensor 26.

Additionally, beverage-dispensing machine 10 may have a pressure transducer 28 located at each of the ingredient supply to determine availability of the ingredient. Pressure transducer 28 is connected to control unit 25 (the connections are not shown in the drawings), and measures the pressure of the ingredients to ensure that corresponding ingredients are available to machine, senses when the ingredients runs out, and send an ingredient supply signals to control unit 25.

Beverage-dispensing machine 10 can also include a device to sense a fault operation of the machine. In the embodiment shown in FIG. 1, beverage-dispensing machine 10 includes a fault operation sensor 30. Fault operation sensor 30 may sense, for example, an abnormal pressure in mixing chambers 22, syrup tanks 16, or CO₂ tank 20, and sends a signal to control unit 25 to inform the fault operation of the machine. Some examples of the fault operation sensed by fault operation sensor 30 may include: Syrup Low/Out, CO₂ Low/Out, Water Low/Out, High Pressure Compressor Cut-off, Beater Motor Overload, Thermistor Short, Thermistor Open, Low Pressure—Syrup, Low Pressure—CO₂, Low Pressure—Water, Barrel Not Cooling, Barrel Temperature too High, Improper Viscosity Settings in Hedlunds (Hd), Improper Raw Viscosity, Improper Compressor Cycle Times, Improper Calibration settings, Proximity probe calibration, Improper Cycle Set Points, Syrup Pump/Regulator Failure, Water Pump/Regulator Failure, and Refrigeration failure. These fault operations of the machine may be informed to the user by a device, such as a light-emitting diode (LED).

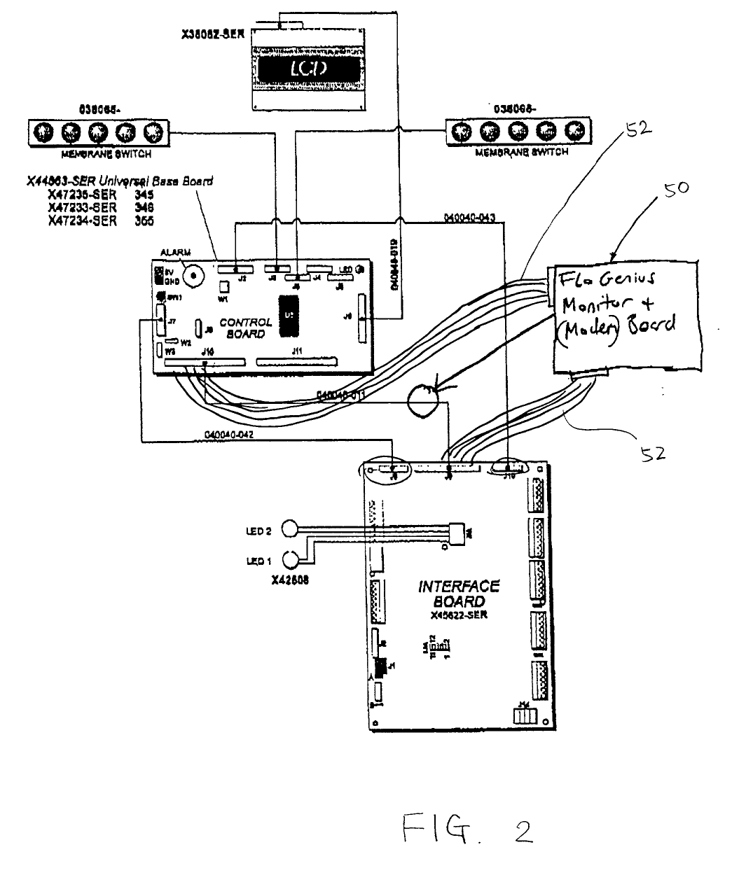

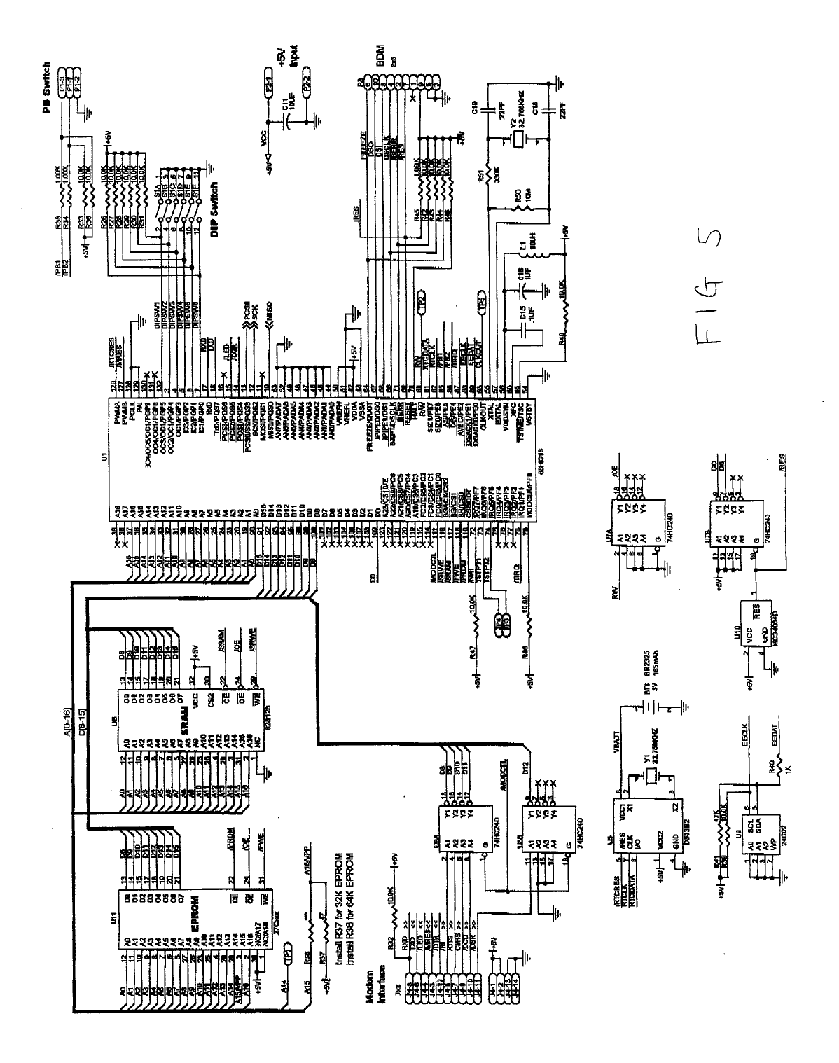

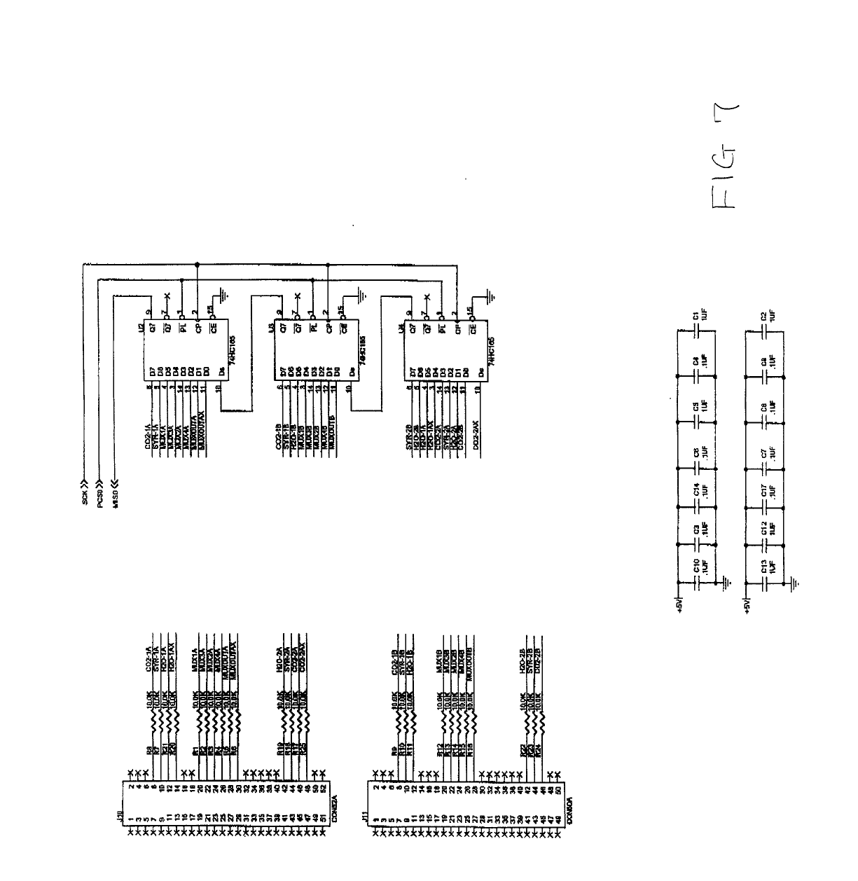

As illustrated in FIGS. 1 and 2, beverage-dispensing machine 10 includes a monitoring system 50. Preferably, monitoring system 50 is attached to beverage-dispensing machine 10 and connected to the machine via a communication line 52, such as a ribbon cable. However, the connection of monitoring system 50 to the machine is not limited to a ribbon cable. Monitoring system 50 may be directly connected to beverage-dispending machine 10 via an adapter without communication line 52 or any other connection that would be apparent to one skilled in the art from consideration of this specification. FIGS. 5-7 show one preferred embodiment of a circuit of monitoring system 50.

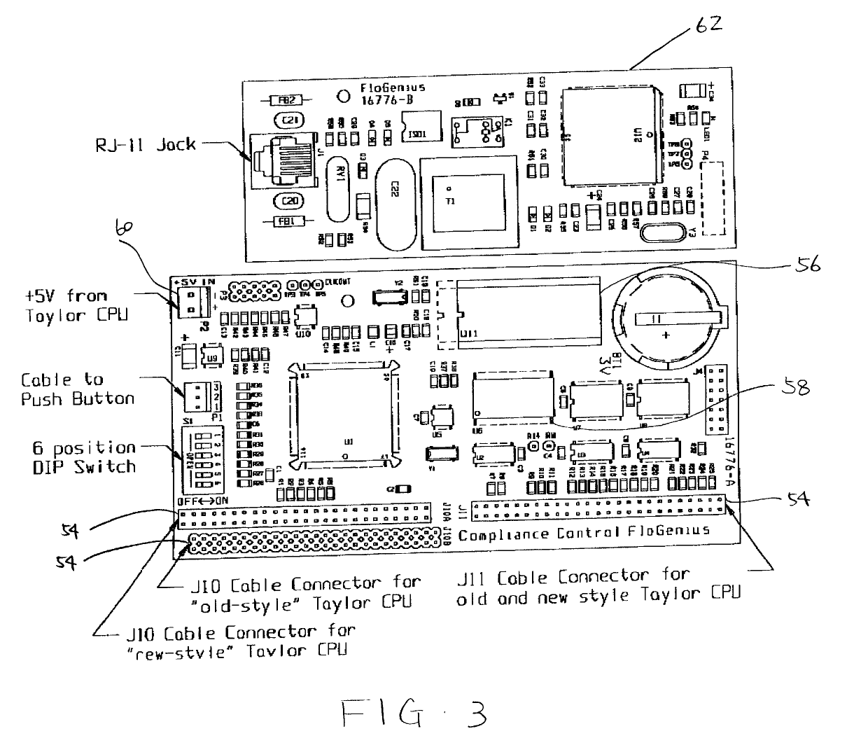

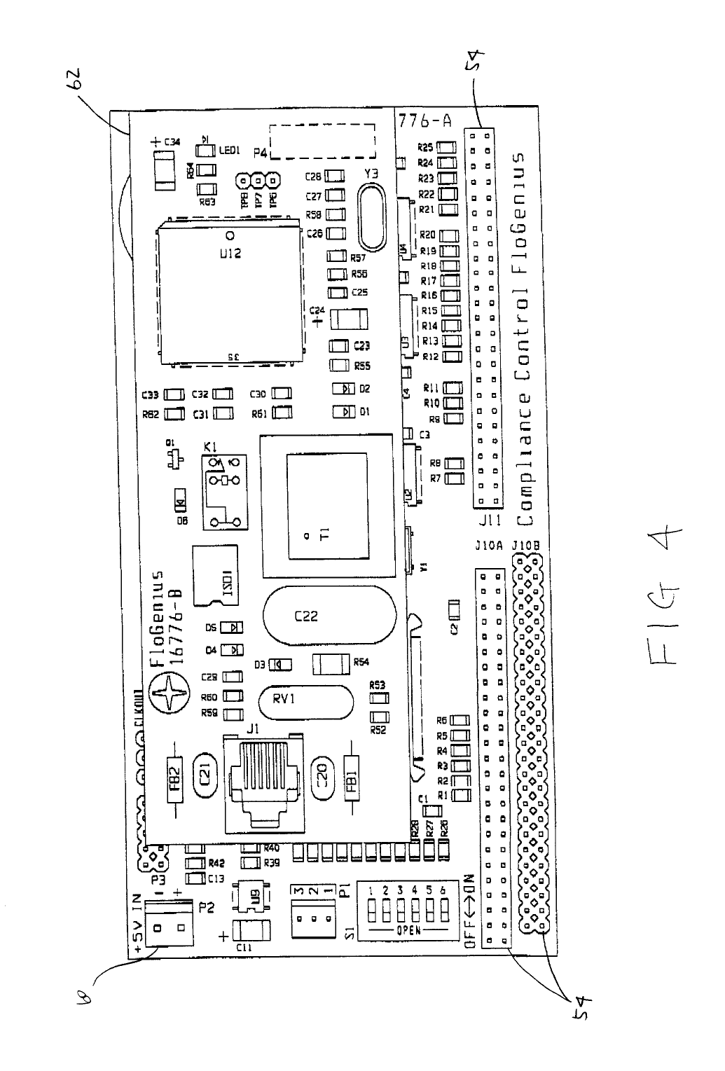

In a preferred embodiment, monitoring system 50 includes an input port 54 configured to be coupled each of the sensors 26, 30 via control unit 25 in beverage-dispensing machine 10. As shown in FIG. 3 and 4, monitoring system 50 may have multiple input ports to accommodate different types of beverage-dispending machines.

Monitoring system 50 also is provided with a monitoring unit 56 connected to input port 54. In one embodiment, monitoring unit 56 is connected to control unit 25 and intercepts signals sent or received by control unit 25. Those signals include, for example, the valve signal sent by control unit 25 to control the opening and closing operation of valve 14, the pressure signal received from pressure transducer 28 at the ingredient supply to determine availability of the ingredient, and waning signals sent from fault operation sensor 30.

In another embodiment, monitoring unit 56 receives a signal from the measurement sensors, such as ingredient volume sensor 26 and pressure transducer 28, and generates an ingredient use signal. The ingredient use and status signal may contain information related to consumption of each of the ingredients for a beverage, for example, how much each ingredient for a beverage has been consumed and whether the ingredients are available to beverage-dispensing machine 10. As shown in FIGS. 1 and 3, monitoring system further includes a memory device 58 connected to monitoring unit 56. Memory device 58 may be a semi-conductor chip and stores the ingredient use signal to generate an ingredient use data set. Memory device 58 may also store fault history data that includes fault operation data collected over a period of time. In one preferred embodiment, the ingredient use and status data includes a compilation of ingredient use and status data for each of the ingredients.

Monitoring system 50 also has a power source 60 for supplying power to monitoring system 50. In this embodiment, power source 60 is connected to control unit 35 of beverage-dispensing machine 10. However, power source 60 may directly receive power from a power supply. Power source 60 should supply suitable power for the operation of monitoring system 50. In one preferred embodiment, monitoring system consumes approximately 80 mA from +5 V power source, and approximately 110 mA during active modem communication.

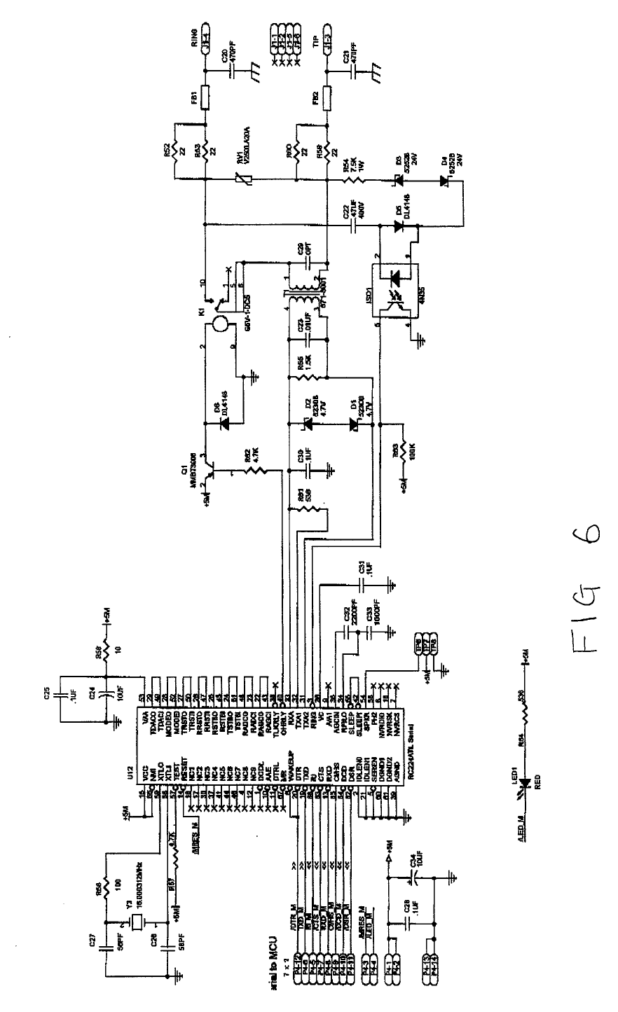

In one preferred embodiment, monitoring system 50 contains a communication device 62 connected to memory device 58. Communication device 62 may be a modem and is connected to a computer 66 in a remote location via a network 64, such as a telephone network or the Internet. Communication device 62 may include a port, such as a telephone jack, to be connected to network 64. The port may provide a hard-wired connection to network 64 to avoid inadvertent disconnection after the installation of monitoring system 50 to beverage-dispending machine 10. FIG. 6 illustrates a circuit diagram of communication device 62.

The information gathered from beverage-dispensing machine 10 can be readily fed to computer 66 via network 64, and at a remote site, the condition of beverage-dispensing machine and the ingredients can be monitored. Computer 66 may be located at a remote location. In one embodiment, average active modem communication duration may be less than 10 seconds per transmission and has an average frequency of between one and four transmission per 30-day period. The communication duration and transmission frequency, however, can be readily changed to a desired value.

In addition to the aforementioned data, monitoring system 50 may also monitor the following items via a sensor, such as fault operation sensor 30, located at beverage-dispensing machine 10: Barrel Temperature, Raw Viscosity, Compressor Cycle Times, Calibration Settings, Proximity Probe Calibration, Rinse Settings (Start/Stop/Duration), Cycle Set Points, Condenser Fan, Beater Motor, Brix (Sweetness), Syrup Sentry, Pressure Relief Valves (Carbonator/Syrup Tank), Pressure Settings (Syrup Tanks, CO₂ Tanks, Freezing Cylinders), and Refrigeration System. When fault operation sensor 30 senses malfunction, it sends a warning signal to control unit 25. Monitoring unit 56 of monitoring system 50 receives the warning signal and generates a fault indicator signal. Preferably, the fault indicator signal can be transmitted by communication device 62 to a remote location to monitor the operation of beverage-dispensing machine from the remote cite.

Monitoring system 50 may also monitor fault history data based on time and date. The fault history data may include: Syrup Low/Out, CO₂ Low/Out, Water Low/Out, High Pressure Compressor Cut-Off, Beater Motor Overload, Thermistor Short, Thermistor Open, Low Pressure—Syrup, Low Pressure—CO₂, Low Pressure—Water, Barrel Not Cooling, Barrel Temperature Too High, Improper Viscosity Settings In Hedlunds (Hd), Improper Raw Viscosity, Improper Compressor Cycle Times, Improper Calibration Settings, Proximity Probe Calibration, Improper Cycle Set Points, Syrup Pump/Regulator Failure, Water Pump/Regulator Failure, and Refrigeration Failure.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A monitoring system for monitoring usage and status of a beverage-dispensing machine, the system comprising:
an input port configured to be coupled to the beverage-dispensing machine;
a monitoring unit connected to the input port, for receiving a monitor signal from the beverage-dispensing machine and generating an ingredient use and status signal;
a memory device connected to the monitoring unit, for storing the ingredient use signal to generate ingredient use and status data; and
a power source supplying power to the monitoring system.

2. The monitoring system of claim 1, further comprising a communication device connected to the memory device, for sending the ingredient use and status data to a remote location via a communication link.

3. The monitoring system of claim 1, wherein the monitoring unit is configured to receive the monitor signal from a control unit of the beverage-dispensing machine.

4. The monitoring system of claim 3, wherein the monitor signal includes at least one of a valve signal, a pressure signal, and a warning signal.

5. The monitoring system of claim 4, wherein the monitoring unit is configured to determine a volume of an ingredient traveling through a valve of the beverage-dispensing machine from the valve signal, and generate ingredient volume signal.

6. The monitoring system of claim 4, wherein the monitoring unit is configured to determine availability of an ingredient to the beverage-dispensing machine from the pressure signal, and generate an ingredient availability signal.

7. The monitoring system of claim 4, wherein the monitoring unit is configured to generate a fault indicator signal from the warning signal from the beverage-dispensing machine.

8. The monitoring system of claim 1, wherein the monitoring unit is configured to receive the monitor signal from a sensor equipped in the beverage-dispending machine.

9. The monitoring system of claim 8, wherein the sensor is a valve sensor for a valve of the beverage-dispensing machine, and the monitoring unit is configured to determine a volume of an ingredient traveling through the valve from the monitor signal and generate an ingredient volume signal.

10. The monitoring system of claim 8, wherein the sensor is a pressure sensor, and the monitoring unit is configured to determine availability of an ingredient to the beverage-dispensing machine from the monitor signal and generate an ingredient availability signal.

11. The monitoring system of claim 1, wherein the memory device is configured to store fault history data.

12. The monitoring system of claim 1, wherein the monitoring unit generates the ingredient use and status signal for at least one of beverage syrup, water and carbon dioxide, and wherein the ingredient use and status data includes data for the one of beverage syrup, water and carbon dioxide.

13. A beverage-dispensing machine, comprising:
a beverage-dispensing nozzle;
an ingredient supply connected to the nozzle;
a valve disposed between the nozzle and the ingredient supply;
a control unit coupled to the valve, for control opening and closing of the valve; and
a monitoring system including:
an input port configured to be coupled to the control unit;
a monitoring unit connected to the input port, for receiving a monitor signal from the control unit and generating an ingredient use and status signal;
a memory device connected to the monitoring unit, for storing the ingredient use and status signal to generate ingredient use and status data; and
a power source for supplying power to the monitoring system.

14. The beverage-dispensing machine of claim 13, further comprising a communication device connected to the memory device, for sending the ingredient use and status data to a remote location via a communication link.

15. The beverage-dispensing machine of claim 13, wherein the monitor signal includes at least one of a valve signal, a pressure signal and a warning signal.

16. The beverage-dispensing machine of claim 15, wherein the monitoring unit receives the valve signal, determines a volume of an ingredient traveling through the valve from the valve signal, and generates ingredient volume data.

17. The beverage-dispensing machine of claim 15, wherein the monitoring unit receives the pressure signal, determines availability of an ingredient to the beverage-dispensing machine from the pressure signal, and generates ingredient availability data.

18. The beverage-dispensing machine of claim 15, wherein the monitoring unit receives the warning signal and generates a fault indicator signal.

19. The beverage-dispensing machine of claim 13, wherein the memory device stores fault history data.

20. The beverage-dispensing machine of claim 13, wherein the ingredient supply includes at least one of beverage syrup, water and carbon dioxide, and the ingredient use and status data set includes data set for at least one of beverage syrup, water and carbon dioxide.

21. A method of monitoring usage and status of a beverage-dispensing machine having a control unit, the method comprising the steps of:
coupling a monitoring unit to the control unit;
receiving a monitor signal from the control unit;
generating an ingredient use and status signal from the monitor signal;
storing the ingredient use and status signal; and
generating ingredient use and status data from the ingredient use and status signal.

22. The method of claim 21, further comprising the step of sending the ingredient use and status data via a communication link to a remote location.

23. The method of claim 21, further comprising the step of determining a volume of an ingredient traveling through a valve of the beverage-dispensing machine.

24. The method of claim 21, further comprising the step of determining availability of an ingredient to the beverage-dispensing machine.

25. The method of claim 21, further comprising the step of generating a fault indicator signal when a fault operation of the beverage-dispensing machine occurs.

26. The method of claim 21, further comprising the step of storing fault history data.

27. The method of claim 21, wherein the ingredient use and status signal generating step includes generation of the ingredient use and status signal for at least one of beverage syrup, water and carbon dioxide, and wherein the ingredient use and status data set generating step includes generation of the data set for at least one of the beverage syrup, water and carbon dioxide.
